(19) United States
(12) Patent Application Publication
(10) Pub. No.: US 2005/0034483 A1
(43) Pub. Date: Feb. 17, 2005

(54) Method for producing silica glass

(76) Inventors: Koichi Sakaguchi, Osaka (JP); Toshinobu Yoko, Uji-shi (JP); Takashi Uchino, Kobe-shi (JP); Akifumi Sakoh, Uji-shi (JP)

Correspondence Address: BIRCH STEWART KOLASCH & BIRCH, PO BOX 747, FALLS CHURCH, VA, 22040-0747, US

(21) Appl. No.: 10/492,090

(22) PCT Filed: Oct. 25, 2002
(86) PCT No.: PCT/JP02/11104

(30) Foreign Application Priority Data
Oct. 30, 2001 (JP) 2001-332699

(51) Int. Cl. C03B 19/09

(52) U.S. Cl. 65/17.3

(57) ABSTRACT

According to the present invention, there is provided a method for manufacturing silica glass of a bulk state as dense as conventional fused silica by a low-temperature process. Fumed silica particles are produced by oxidizing and hydrolyzing SiCl₄ gas with a flame of 1100-1400° C. which is obtained by burning mixed gas of H₂ and O₂. Such fumed silica particles are used as a raw material, and pressure is applied to the aggregate of the fumed silica particles so as to unite the particles with respect to each other.

### TECHNICAL FIELD

This invention relates to a manufacturing method of silica glass.

### BACKGROUND ART

Since the component of silica glass is substantially only SiO₂, the chemical durability is good, the coefficient of thermal expansion is small, and the transparency is high in a case of including a small amount of impurities. Therefore, silica glass has been widely used mainly for optical use. Silica glass of a bulk state such as a tube, a rod, or the like has been manufactured by fusing quartz. In order to manufacture a fiber for optical communication, processes such as CVD for obtaining a material of high purity have been employed.

However, the high viscosity of silica glass requires an extremely high fusion temperature. Therefore, even if a component other than SiO₂ is tried to be added so as to impart some function, it is difficult to add a component which is transformed or volatilized at high temperature.

The present invention has been made to solve the above-mentioned problem, and the object of the present invention is to provide a method for manufacturing silica glass of a bulk state at low temperature.

As the prior art materials which pertain to the present invention, Japanese Patent Application Publication 11-139838 and Japanese Patent Application Publication 2001-89168 can be listed.

### DISCLOSURE OF THE INVENTION

According to the present invention, there is provided a manufacturing method of silica glass comprising the steps of aggregating fumed silica particles which are used as a raw material, and applying pressure to the aggregated fumed silica particles so as to unite the particles with respect to each other.

The fumed silica particles used in the present invention are produced by oxidizing and hydrolyzing SiCl₄ gas with a flame of 1100-1400° C. which is obtained by burning mixed gas of H₂ and O₂. The particles have a very small diameter, and since the particles are produced in a quenching state, the surface structure of the particles is in an active state differently from the case of common silica glass. More specifically, the glass structure formed by Si—O—Si bonds is extremely deformed in the surface of the particles, and thereby the surface of the particles has high chemical reactivity. When such particles are used as a raw material and compacted by applying pressure, the particles can be bonded at relatively low temperature due to the high activity of the surface of the particles. Accordingly, silica glass can be produced at room temperature, for example.

In the above-mentioned manufacturing method, heating treatment may be conducted to the fumed silica particles before applying pressure. By doing so, it is possible to reduce adsorbed water and organic components in the surface of the fumed silica, and thereby promote bonding of the particles.

It is preferable to conduct the heating treatment to the fumed silica particles at a reduced pressure of 0.1 Pa or less so as to improve the reaction activity of the particles and thereby promote the surface reaction more efficiently. By doing so, it is possible to reduce adsorbed water and organic components in the surface of the fumed silica more and more, and thereby improve the reaction activity of the surface of the particles. For example, by conducting the above-mentioned heating treatment preferably for 2 hours at a temperature of 1000° C. at a reduced pressure of 10⁻³ Pa, the surface reaction of the particles at the time of applying pressure can be promoted.

Mechanical agitation may be conducted to the fumed silica particles before applying pressure. By doing so, the surface of the particles is activated more and more in the process where the particles collide with each other. As an example of the mechanical agitation, agitation with a ball mill can be listed. As a preferable method, the fumed silica particles are agitated by using a planetary-type ball mill for 10-30 minutes at a rate of 300-600 revolutions per minute.

It is preferable to heat the aggregated particles at the time of applying pressure. By doing so, it is possible to promote bonding of the particles more and more, and thereby silica glass can be manufactured more efficiently. If the heating temperature is too high, the surface of the particles will possibly be transformed and the chemical reactivity will be lost. Therefore, it is preferable to keep the heating temperature less than 500° C., and more preferably less than 250° C.

The diameter of the fumed silica particles is preferably in the range of 1 to 300 nm. If the diameter is less than 1 nm, the yield of preparing the particles is poor, and thereby the cost becomes high. Also, if the diameter exceeds 300 nm, the chemical activity of the surface is low, and the bonding effect of the particles at the time of applying pressure is deteriorated. More preferably, the range is from 3 to 100 nm, and more preferably from 5 to 50 nm.

It is preferable to keep the pressure applied to the aggregated particles in the range of 2 to 20 GPa. The bonding effect of the particles is low in a case where the applied pressure is less than 2 GPa. Also, the load of the manufacturing process is too great in a case where the applied pressure exceeds 20 GPa. More preferably, the range is from 6 to 10 GPa.

### BEST MODE FOR CARRYING OUT THE INVENTION

Hereinafter, the embodiments of the present invention will be described.

### EXAMPLE 1

Fumed silica particles having an average diameter of 7 nm and a specific surface area of 390 m²/g were used as a raw material. The particles were heated to 1000° C. in advance, so as to reduce hydrocarbon-based impurities and OH groups of the surface. The fumed silica particles were filled into a cell which is made of boron nitride, and a pressure of 8 GPa was applied thereto for 30 minutes at room temperature in a condition of hydrostatic pressure by using a cubic type anvil cell. A sample of a cylindrical shape having a diameter of 3 mm and a thickness of 1 mm was obtained. Also, the sample was transparent and its density was 2.20 g/cm³. This value was similar to that of fused silica, which shows that a dense material was obtained.

### EXAMPLES 2-4

Samples were manufactured in the same way as Example 1 except that the applied pressure and the temperature at the time of applying pressure were changed. The manufacturing condition and the density of each sample are shown in Table 1. All the samples were dense and transparent.

TABLE 1

| Manufacturing | | | |
|---|---|---|---|
| conditions | Example 2 | Example 3 | Example 4 |
| Applied pressure | 6 | 6.5 | 7.5 |
| (GPa) | | | |
| Heating | 200 | 150 | 100 |
| temperature (° C.) | | | |
| Density | 2.20 | 2.20 | 2.20 |
| (g/cm³) | | | |

### COMPARATIVE EXAMPLE 1

SiO₂ powder having an average diameter of 1 μm whose purity was made 99.99 mass % or more by conducting acid cleaning to silica sand was used as a raw material. The other conditions were the same as those of Example 1. However, even after pressure was applied, the powder was not united. Also, even in a case where the particles were heated to 500° C. at the time of applying pressure, the particles were not bonded with respect to each other, and the sample in which the particles were united was not obtained. Therefore, this comparative example is not in the scope of the present invention.

### INDUSTRIAL APPLICABILITY

As described above, by the manufacturing method of silica glass according to the present invention, a material as dense as common silica glass is obtained even in a low-temperature process.

1. A manufacturing method of silica glass comprising the steps of:
aggregating fumed silica particles which are used as a raw material; and
applying pressure which is in the range of 2 to 20 GPa to the aggregated fumed silica particles so as to unite the particles with respect to each other.

2. The manufacturing method of silica glass according to claim 1, wherein heating treatment is conducted to the fumed silica particles before the step of applying pressure.

3. The manufacturing method of silica glass according to claim 2, wherein the heating treatment is conducted at reduced pressure of 0.1 Pa or less.

4. The manufacturing method of silica glass according to claim 1 or 2, wherein mechanical agitation is conducted to the fumed silica particles before the step of applying pressure.

5. The manufacturing method of silica glass according to claim 1, wherein the aggregated fumed silica particles are heated in the step of applying pressure.

6. The manufacturing method of silica glass according to claim 1, wherein the diameter of the fumed silica particles is in the range of 1 to 300 nm.

7. (Cancelled)
